(19) United States
(12) Patent Application Publication
(10) Pub. No.: US 2005/0047892 A1
(43) Pub. Date: Mar. 3, 2005

(54) Laser cut apertures for thread forming fasteners

(76) Inventor: Ronald Dean Bremner, Cedar Falls, IA (US)

Correspondence Address: W. Michael Dixon;Patent Department, DEERE & COMPANY, One John Deere Place, Moline, IL, 61265-8098, US

(21) Appl. No.: 10/651,778

(22) Filed: Aug. 29, 2003

(51) Int. Cl. F16B 37/16

(52) U.S. Cl. 411/437

(57) ABSTRACT

An aperture is provided for metal parts using conventional laser cutting techniques and equipment. The aperture has a generally eye shaped periphery. The eye shape allows thread forming fasteners to engage a portion of the aperture wall while a portion of the wall does not contact the fastener i.e. at the corners of the eye. Because the aperture walls do not have surface contact around the entire circumference of the fastener the frictional resistance and thus the driving torque required for driving thread forming fasteners is reduced significantly. The particular shape described provides an optimum compromise between the need to reduce driving force and the need to provide sufficient surface contact to maintain firm engagement of the fastener in the aperture.

### FIELD OF THE INVENTION

The present invention relates generally to fastener apertures in metal parts. More particularly, the present invention relates to such fastener apertures which are made using laser cutting devices. Specifically, the present invention relates to such laser cut apertures which are optimized for use with thread forming screws.

### BACKGROUND OF THE INVENTION

In recent years it has become increasingly more common to utilize various laser devices in manufacturing operations. In particular laser cutting devices are being widely used in conjunction with computer aided manufacturing techniques due to the high speed and accuracy that is attainable with such devices and techniques. One drawback to using laser devices for making apertures in steel is that the aperture walls become very hard due to the intense heat from the laser. Further when a laser cutting device is employed to create a fastener aperture the laser is first applied to the material at a given point and then cuts in a circle thereby finishing at the starting point, this start/stop point typically has a jagged edge or burr. In cases where it is desirable and/or necessary to employ thread forming fasteners in the laser cut apertures, the amount of torque required to drive the fastener is considerable and the fasteners are prone to frequent breakage due to the hardness of the aperture walls and the jagged edge or burr at the stop/start point. The means commonly used to overcome this problem is to re-drill the aperture after it is cut or to anneal the part. Another drawback to using laser devices to create round thread forming fastener apertures is that very tight tolerances must be maintained. This is due to the fact that the thread forming fastener necessarily must displace a certain amount of material during the forming of threads, because only a certain amount of material displacement is possible for a given material, the tolerance of the aperture must be tightly maintained. Very tight tolerances are not always attainable with current laser cutting devices. Because of this thread forming fasteners are seldom used with laser cut holes.

Accordingly, there is a clear need in the art for a laser cut aperture which is suitable for use with thread forming fasteners.

### SUMMARY OF THE INVENTION

In view of the foregoing, it is an object of the invention to provide fastener apertures in metal parts.

Another object of the invention is the provision of such apertures using laser cutting devices.

A further object of the invention is to provide such apertures which are suitable for use with thread forming fasteners without the need to re-drill the aperture or to anneal the part.

An additional object of the invention is the provision of such apertures without complexity and using known manufacturing equipment.

The foregoing and other objects of the invention together with the advantages thereof over the known art which will become apparent from the detailed specification which follows are attained by a laser cut aperture having at least one wall for engagement of a thread forming fastener, the thread forming fastener having a circumferential outer surface wherein at least one portion of at least one wall contacts the circumferential outer surface of the fastener and at least one portion of at least one wall does not contact the circumferential outer surface of the fastener whereby the torque required to drive the thread forming fastener in the aperture is reduced.

Other objects of the invention are attained by a fastener aperture in a metal part wherein a laser cutting device is employed to create the aperture, the aperture comprising: an eye shaped peripheral wall having a rounded center portion and an angled corner portion on two sides of the rounded center portion, an angle of the angled corner portions being in the range of 90 to 150 degrees whereby a thread forming fastener having a circumferential outer surface engages the peripheral wall in the area of the rounded center portion but does not engage the peripheral wall in the area of the angled corner portions thereby reducing the torque required to drive the fastener.

In general, an aperture is provided for metal parts using conventional laser cutting techniques and equipment. The aperture has a generally eye shaped periphery. The eye shape allows thread forming fasteners to engage a portion of the aperture wall while a portion of the wall does not contact the fastener i.e. at the corners of the eye. Because the aperture walls do not have surface contact around the entire circumference of the fastener the frictional resistance and thus the driving torque required for driving thread forming fasteners is reduced significantly. The particular shape described provides an optimum compromise between the need to reduce driving force and the need to provide sufficient surface contact to maintain firm engagement of the fastener in the aperture.

To acquaint persons skilled in the art most closely related to the present invention, one preferred embodiment of the invention that illustrates the best mode now contemplated for putting the invention into practice is described herein by and with reference to, the annexed drawings that form a part of the specification. The exemplary embodiment is described in detail without attempting to show all of the various forms and modifications in which the invention might be embodied. As such, the embodiment shown and described herein is illustrative, and as will become apparent to those skilled in the art, can be modified in numerous ways within the spirit and scope of the invention—the invention being measured by the appended claims and not by the details of the specification.

### BRIEF DESCRIPTION OF THE DRAWINGS

For a complete understanding of the objects, techniques, and structure of the invention reference should be made to the following detailed description and accompanying drawing, wherein:

FIG. 1 is a plan view of a portion of a metal part employing an exemplary aperture according to the invention.

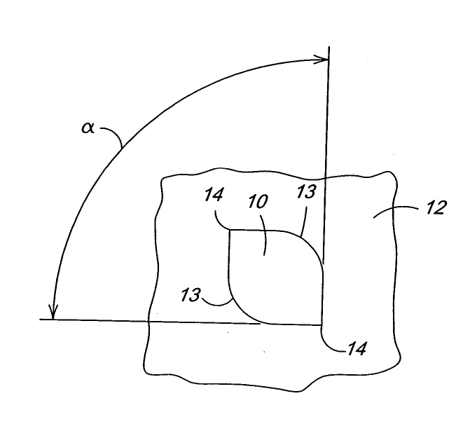

### DESCRIPTION OF THE PREFERRED EMBODIMENT

With reference now to the drawing it can be seen that an exemplary fastener aperture according to the invention is designated generally by the numeral 10. The aperture 10 is provided in a metal part 12 using conventional laser cutting techniques and equipment. As can be seen aperture 10 has a generally eye shaped periphery. This shape allows thread forming fasteners to engage a rounded center portion 13 of the aperture wall while a portion of the wall does not contact the fastener i.e. at the corners 14 of the eye. Because the aperture walls do not have surface contact around the entire circumference of the fastener the frictional resistance and thus the driving torque required for driving thread forming fasteners is reduced significantly. In the exemplary embodiment illustrated an angle designated α is shown at 90°, however it has been found that the aperture 10 works well with thread forming fasteners when the angle α is in the range of 90° to 150°. As a general rule the greater the angle α the more surface contact there will be between the thread forming fastener and the aperture walls. Thus the range of angles described above provides an optimum compromise between the need to reduce driving force and the need to provide sufficient surface contact to maintain firm engagement of the fastener in the aperture.

Further advantages of the aperture of the invention are attained due to the fact that the start/stop points for the laser can be at the corners 14, thus any jagged edge or burr resulting from the laser cutting process will not interfere with the thread forming fastener inasmuch as the thread forming fastener will not be contacting the aperture wall at the corners 14. Another advantage is that wider tolerances are possible with the aperture of the invention because a certain amount of material displaced in the thread forming process is displaced into the area not contacted by the fastener, that is to say toward the corners of the eye. For example, it has been found that for apertures in the 6-8 mm range the tolerance is approximately three times that of a like-sized round aperture. With apertures in the range of 6-8 mm made in accordance with the invention it is possible to specify a tolerance of ±/−0.15 mm which is well within the range of typical laser cutting devices. A like-sized round aperture would require a tolerance of +0.0, −0.05 for use with thread forming fasteners. Such a tight tolerance is just not attainable with most conventional laser cutting devices

It is contemplated that other aperture shapes could be utilized within the spirit and scope of the invention to reduce the amount of frictional surface contact between the fastener and the aperture wall and thereby also reduce the torque necessary to drive a thread forming fastener. It being necessary within the scope of the invention to provide a portion of the aperture wall which does not contact the screw circumference wherein this non-contacted portion is great enough to significantly reduce driving torque. The preferred eye shaped embodiment was chosen as optimal for providing an aperture which is readily produced using known laser cutting devices and techniques at or near the same cost and speed as conventional round apertures.

Thus it can be seen that the objects of the invention have been satisfied by the structure presented above. While in accordance with the patent statutes, only the best mode and preferred embodiment of the invention has been presented and described in detail, it is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A laser cut aperture having a generally eye shaped peripheral wall having a rounded center portion for engagement of a thread forming fastener and two angled corner portions wherein an angle of the angled corner portions is in the range of 90 to 150 degrees, the thread forming fastener having a circumferential outer surface wherein at least one portion of the rounded center portion contacts the circumferential outer surface of the fastener and the two angled corner portions do not contact the circumferential outer surface of the fastener whereby the torque required to drive the thread forming fastener in the aperture is reduced.

2. (Cancelled)

3. A laser cut aperture as set forth in claim 1 wherein the circumferential outer surface of the thread forming fastener contacts the rounded center portion of the wall and does not contact the wall at the angled corner portions.

4. A laser cut aperture as set forth in claim 1 wherein a start/stop point for a laser cutting device is located at one of the angled corner portions.

5. (Cancelled)

6. A fastener aperture in a metal part wherein a laser cutting device is employed to create the aperture, the aperture comprising:
an eye shaped peripheral wall having a rounded center portion and an angled corner portion on two sides of the rounded center portion, an angle of the angled corner portions being in the range of 90 to 150 degrees
whereby a thread forming fastener having a circumferential outer surface engages the peripheral wall in the area of the rounded center portion but does not engage the peripheral wall in the area of the angled corner portions thereby reducing the torque required to drive the fastener.

7. A fastener aperture as set forth in claim 6 wherein a start/stop point for the laser cutting device is located at one of the angled corner portions.
